(19) United States
(12) Patent Application Publication
(10) Pub. No.: US 2018/0118060 A1
(43) Pub. Date: May 3, 2018

(54) INCREMENTALLY ADJUSTABLE SEAT ASSEMBLY

(71) Applicants: Winsen C. ZOUZAL, (US); Lear Corporation, Southfield, MI (US)

(72) Inventors: Winsen C. ZOUZAL, Detroit, MI (US); Gerald PATRICK, Shelby Township, MI (US)

(21) Appl. No.: 15/337,057

(22) Filed: Oct. 28, 2016

(51) Int. Cl. B60N 2/44; B60N 2/66; B60N 2/02; G05D 16/20

(52) U.S. Cl. CPC B60N 2/4415; G05D 16/2073; B60N 2/0244; B60N 2/665

(57) ABSTRACT

A seat assembly is provided with a seat back, and with an actuator that is oriented in a region of the seat back to adjust a seating surface of the seat back. A controller is in electrical communication with the actuator. The controller is programmed to operate the actuator to partially adjust the seating surface toward a target position. Subsequently, the controller operates the actuator to further actuate the actuator after a predetermined delay to further adjust the seating surface toward the target position. The controller is programmed to receive input indicative of a selection of a mode of seat adjustment. The actuator is operated to gradually adjust the seating surface to a target position after a quantity of events associated with the selected mode of seat adjustment.

### TECHNICAL FIELD

Various embodiments relate to adjustable seat assemblies.

### BACKGROUND

An adjustable seat assembly is illustrated and described in U.S. Pat. No. 5,758,924, which issued on Jun. 2, 1998 to Lear Corporation.

### SUMMARY

According to at least one embodiment, a seat assembly is provided with a seat back, and with an actuator that is oriented in a region of the seat back to adjust a seating surface of the seat back. A controller is in electrical communication with the actuator. The controller is programmed to operate the actuator to a first adjustment position to partially adjust the seating surface toward a target position. Subsequently, the controller operates the actuator to further actuate the actuator after a predetermined delay to further adjust the seating surface to a second adjustment position toward the target position.

According to at least another embodiment, a seat assembly is provided with a seat back, and with an actuator oriented in a region of the seat back to adjust a seating surface of the seat back. A controller is in electrical communication with the actuator. The controller is programmed to receive input indicative of a selection of a mode of seat adjustment. The actuator is operated to gradually adjust the seating surface to a target position after a predetermined quantity of events associated with the selected mode of seat adjustment.

According to at least one embodiment, a computer-program product is embodied in a non-transitory computer readable medium that is programmed to adjust a seat assembly. The computer-program product is provided with instructions to operate an actuator oriented in a region of a seat back to adjust a seating surface of the seat back to a first adjustment position toward a target position. Subsequently, the actuator is operated to further actuate the actuator after a predetermined delay to further adjust the seating surface to a second adjustment position toward the target position.

According to at least another embodiment, a computer-program product is embodied in a non-transitory computer readable medium that is programmed to adjust a seat assembly. The computer-program product is provided with instructions to receive input indicative of a selection of a mode of seat adjustment. An actuator that is oriented in a region of a seat back, and is operated to adjust a seating surface of the seat back to a target position after a predetermined quantity of events associated with the selected mode of seat adjustment.

### BRIEF DESCRIPTION OF THE DRAWINGS

FIG. 1 is a front perspective view of a vehicle seat assembly, illustrated partially disassembled, according to an embodiment;

FIG. 2 is a rear elevation view of an air bladder assembly array of the seat assembly of FIG. 1, illustrated with a skeletal occupant;

FIG. 3 is a rear elevation view of another air bladder assembly array of the seat assembly of FIG. 1, according to another embodiment, illustrated with a skeletal occupant;

FIG. 4 is a display image of a vehicle seat system, according to an embodiment;

FIG. 5 is another display image of the vehicle seat system of FIG. 4; and

FIG. 6 is a flowchart of a method for adjusting a vehicle seat assembly according to an embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A comfort, posture and wellness seating system for vehicle seat assemblies, provides a visual interface with adjustment hardware organically or inorganically. The system may be employed to properly configure any new or existing seating system. The system can also address specific comfort, posture or preferences, such as thoracic support. The seating system objectifies comfort data and biomechanical knowledge to make the data transferable.

The comfort, posture and wellness seating system integrates anthropometry, bio-mechanics, and historical seating comfort data. The seating system can be employed in original equipment for vehicles or in aftermarket products. Applicable markets include automotive, mass transit, airlines, etc., as well as non-vehicular seating such as office, home, commercial, and public venue seating.

Data collection may be conducted that includes expert positioning of a suitable sample of occupants for optimal comfort or preferred posture by a medical professional. The data collection can be used at specific sites on an ongoing basis if required. The expert input provides a high level of expert comfort, posture and personalized fitting. The data may be based on anthropometry, body pressure distribution (BPD), status of actuators (such as pressure of inflatable air bladders, status of valves or the like), or other data that provides a comfort, posture and biomechanically optimized position of an adjustable vehicle seat assembly. The data is collected in a knowledge base or table for setting adjustments based on categories of data. The knowledge base may be compiled from the expert positioned data and the occupant specific data. The setting adjustments from the knowledge base are utilized for pre-set options in a vehicle seat assembly 10. The setting adjustments can be customized by a user at a controller or display.

Input data can be plotted versus adjustment settings for high level categorization. The settings can be categorized by topology clustering for setting the pre-set options. Various setting options may be provided for various types of driving. For example, a touring setting may provide per package settings and basic comfort, posture and wellness recommendations. The touring setting may also provide optimal visibility, use of features and controls, and the like. A performance setting may be provided for active drivers to provide a more erect position with firmer seating. Additionally, a luxury setting may be more reclined with softer seating.

It is believed that supporting the thoracic region of the spine can reduce forces and support as much as one-third of the upper body mass. By increasing support of the upper body mass, loads are reduced on the muscles, vertebrae, and discs through the spine and pelvic regions. Decreased load reduces fatigue on these areas of the body. The current prevalent comfort back-supporting technology for the furniture and transportation market focuses on the lumbar (lower) region of the back to provide relief from fatigue. With the change from a primarily labor intensive work force to one of computer-using desk workers, we see an increase in low back pain. This is driving the need for an improvement in the location of the seating support system designed to prevent fatigue and the resultant discomfort. By transferring support from solely located in the lumbar region to now include the thoracic region of the spine, load is transferred to a more rigid section of the spinal column as well and a decrease in lower back pain should result.

A seating system for office or home seating furniture or vehicular seating systems, such as in automotive, train, off-road vehicular or aircraft seating, provides supporting pressure along the thoracic region of the user's spine between the T1 to the T12 vertebrae, and lesser support in the lumbar region. The region above the T1 vertebrae is the cervical region; and the regions below the T12 vertebrae are the lumbar, sacral and coccyx regions.

The support structure is to be positioned along the thoracic region of a seat back when the user is seated. The support structure can be used in a variety of seating systems. Some seating systems and components are shown by way of example and are described below.

There are four main factors that affect subjective posture: 1) smoothness of the pressure integral; 2) sufficiency of the pressure change; 3) ability to create even pressure for a wide range of anthropometry; and 4) ergonomic/control suitability of actuation.

A thoracic region seating system design is focused on addressing subjective posture factors. By supporting the thoracic region, the user's load is transferred from the lumbar region to the thoracic region, reducing stress and fatigue in the muscles, tendons, and vertebrae.

A design feature permits even pressure for a wide range of anthropometry, which can be accommodated by having the degree of pressure adjustable.

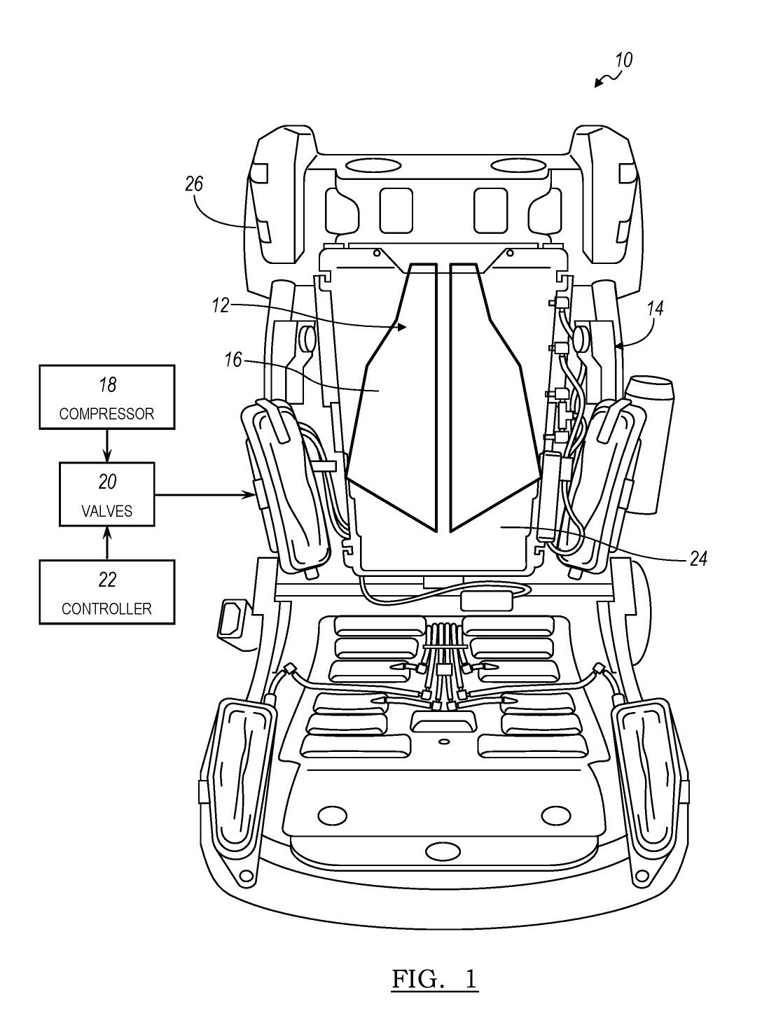

Referring now to FIG. 1, a seat assembly is illustrated partially disassembled to reveal underlying components and is referenced generally by numeral 10. The seat assembly 10 may be a vehicle seat such as for an automobile or an aircraft, an office chair, or any seat assembly that can benefit by an adjustable posture system. The seat assembly 10 is illustrated with an array of bladders that are each adjustable and can be individually or collectively inflated providing support and stimulation at various locations in the seat intended to accommodate different sized and statured individual occupants, as a thoracic support system, which is referenced generally by numeral 12.

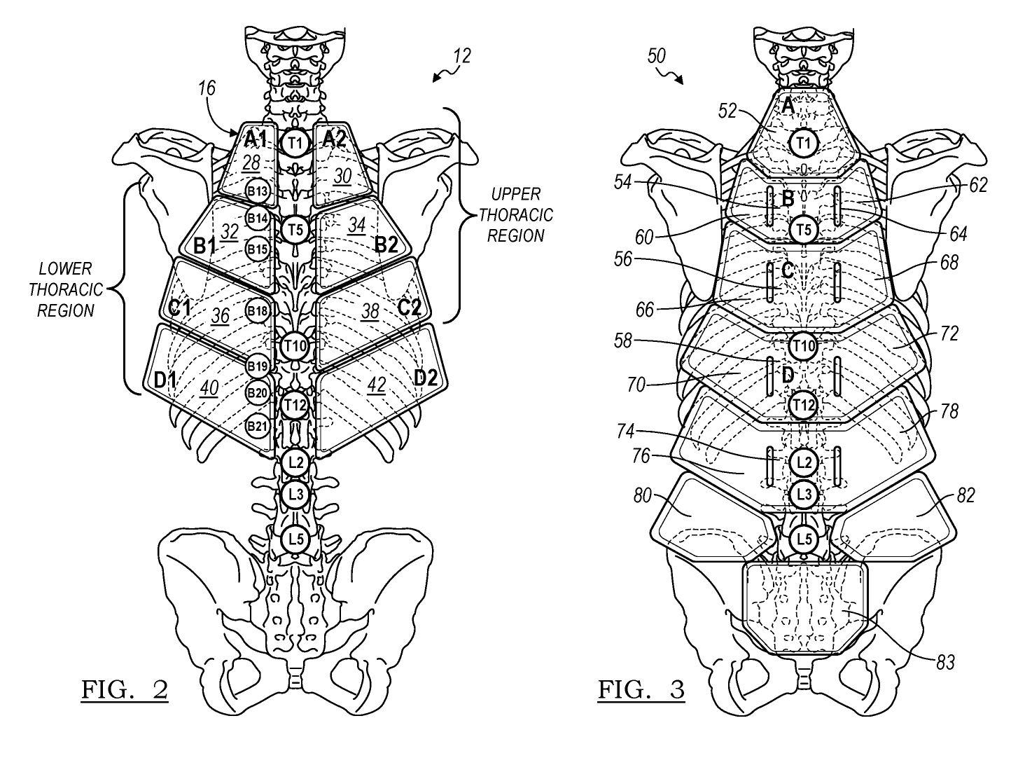

According to one embodiment, the thoracic support system 12 is a power pneumatic system in a seat back 14 which provides support and stimulation to thoracic vertebrae (FIG. 2) and a posterior rib cage (FIG. 2) between the shoulder blades (FIG. 2) to support an occupant to achieve a proper neutral seating posture. The thoracic support system 12 also utilizes pneumatic bag acupressure in the thoracic area of the seat back 14 to stimulate specific pressure points along both sides of the spine to deactivate trigger points which create positive muscle response.

The system supports are separated, and specifically shaped and positioned to stimulate areas along both sides of the thoracic spine. The supports are also inflated and deflated in a specific pattern to create a myofascial release effect to improve wellness and to assist thoracic support by stimulation.

The support system is provided with a plurality of support zones labeled A-D in FIG. 2. The support zones A, B, C, D are individually adjustable to achieve optimum support and stimulation conditions for a variety of postures and occupant sizes.

Referring now to FIGS. 1 and 2, the support system 12 includes an air bladder assembly array 16 that provides the zones A, B, C, D. The support system 12 includes a compressor 18 for providing a source of pressurized air to valves 20. The valves 20 are controlled by a controller 22. The valves 20 are in fluid communication with the zones A, B, C, D for controlling pressure and inflation of the zones A, B, C, D. Likewise, the valves 20 may exhaust the zones A, B, C, D for deflation of the zones. The controller 22 may operate as described in Lear Corporation U.S. Patent Application publication number US 2015/0352979 A1, which is incorporated in its entirety be reference herein. The controller 22 permits individual adjustment of pressure of each of the zones A, B, C, D as specified by an occupant selection or a predetermined pressure setting or program.

The air bladder assembly array 16 is mounted to a suspension 24, such as a wire mat with a felt barrier, which is connected to a frame 26 of the seat back 14 as illustrated in FIG. 1. The air bladder assembly array 16 is oriented in a thoracic region of an occupant's back. In other words, the air bladder assembly array 16 is sized to be located between the shoulder blades and between the T1 and T12 vertebrae for an average occupant as depicted in FIG. 2. The air bladder assembly array 16 is provided with a plurality of support and stimulation regions 28, 30, 32, 34, 36, 38, 40, 42 within the seat back 14. The air bladder regions 28, 30, 32, 34, 36, 38, 40, 42 are arranged in pairs and oriented along an upright direction of the seat back 14 for each of the zones A-D. The air bladder regions 28, 30, 32, 34, 36, 38, 40, 42 are spaced apart laterally to provide a gap aligned with the spine. In order to distribute the air bladder assembly array 16 into zones, the air bladder regions 28, 30, 32, 34, 36, 38, 40, 42 may be formed from various configurations, such as in irregular quadrilateral shapes, such as trapezoids.

Each of the first pair of air bladder regions 28, 30 is tapered outward towards the second pair of air bladder regions 32, 34 to fit between an occupant's shoulder blades with a lower end that is inclined laterally outboard. The second pair of air bladder regions 32, 34 are inclined laterally outward at both top and bottom edges, and is tapered further outboard to support the thoracic region of the occupant. Likewise, each of the third pair of air bladder regions 36, 38 and each of the fourth pair of air bladder regions 40, 42, are inclined laterally outward at top and bottom edges with increasing outward tapers to provide the zones C, D that fit adequately within the thoracic region.

The air bladder assembly array 16 may be employed for thoracic acupressure myofascial release. The power pneumatic/electric system of the controller 22, compressor 18, valves 20 and air bladder assembly array 16 in the seat back 14 may utilize pneumatic bladder acupressure in the thoracic area of the seat back 14 to stimulate specific pressure points along both sides of the spine to deactivate trigger points which create positive muscle response. The air bladder system support regions 28, 30, 32, 34, 36, 38, 40, 42 are separated, and specifically shaped and positioned to stimulate areas along both sides of the thoracic spine. The air bladder regions 28, 30, 32, 34, 36, 38, 40, 42 are also inflated and deflated in specific patterns to create a myofascial release effect to improve wellness and to assist thoracic support and stimulation.

An upper thoracic region is labeled in FIG. 2, which includes zones A-C provided by air bladder regions 28, 30, 32, 34, 36, 38. Dual-sided thoracic upper back support air bladder regions 28, 30, 32, 34, 36, 38 are operated to stimulate muscles along each side of the spine in the T3-T6 region. These areas are traditionally associated with acupressure points B13-B15 which are related with the cardiovascular and respiratory systems. The air bladder regions 28, 30, 32, 34, 36, 38 can be inflated/deflated individually on the right side and left side, or can be inflated/deflated simultaneously. The inflation/deflation sequence can be arranged in multiple patterns as programmed in the controller 22.

A lower thoracic region is also labeled in FIG. 2. Dual sided thoracic middle back air bladder support regions 32, 34, 36, 38, 40, 42 in zones B-D stimulate muscles along each side of the spine in the T7-T12 region. These areas are traditionally associated with acupressure points B18-B21 which are related with the digestive system. The air bladder regions 32, 34, 36, 38, 40, 42 can be inflated/deflated individually on the right side and left side, or can be inflated/deflated simultaneously. The inflation/deflation sequence can be arranged in multiple patterns as programmed in the controller 22.

One such pattern includes concurrently inflating the air bladder regions 28, 30, 32, 34, 36, 38 of the upper thoracic region. Then, the air bladder regions 28, 30, 32, 34, 36, 38 of the upper thoracic region are concurrently deflated. Next, the air bladder regions 32, 34, 36, 38, 40, 42 of the lower thoracic region are concurrently inflated. Then, the air bladder regions 32, 34, 36, 38, 40, 42 of the lower thoracic region are concurrently deflated. This pattern may then be repeated. This pattern may be alternated between right and left sides according to another embodiment.

Another pattern includes concurrently inflating the air bladder regions 28, 30, 32, 34, 36, 38 of the upper thoracic region. Then, the first pair of air bladder regions 28, 30 is concurrently deflated. Next, the fourth pair of air bladder regions 40, 42 is concurrently inflated. Then, the air bladder regions 40, 42 of the lower thoracic region are concurrently deflated. Then the first pair of air bladder regions 28, 30 is inflated. This pattern may then be repeated at the step of deflation of the first pair of air bladder regions 28, 30. This pattern may be alternated between right and left sides according to another embodiment.

Additionally, an array of air pressure sensors may be provided in the air bladder regions 28, 30, 32, 34, 36, 38, 40, 42 to measure air pressure readings that are conveyed to the controller 22. The controller 22 compares air pressure measurements from the left side 28, 32, 36, 40 with the corresponding measurements from the right side 30, 34, 38, 42 to determine if the occupant is seated evenly, for example if three or four of the comparisons are similar. If three comparisons are similar, and one is dissimilar, the controller 22 can determine that the occupant is seated evenly, yet the dissimilar pressure is a result of a tightened muscle within the air bladder region in the dissimilar zone with the greater pressure reading. In response, the associated air bladder region is inflated and deflated to vary pressure in the associated air bladder region to reduce tightness in the affected muscle.

FIG. 3 illustrates an air bladder assembly array 50 according to another embodiment. The air bladder assembly array 50 is provided with a plurality of thoracic support zones labeled A-D in FIG. 3. The thoracic support zones A, B, C, D are individually adjustable to achieve an optimum support condition for a variety of postures and occupant sizes. Similar to the prior embodiment, the valves 20 are in fluid communication with the thoracic support zones A, B, C, D of the for controlling pressure and inflation of the thoracic support zones A, B, C, D. The controller 22 permits individual adjustment of pressure of each of the zones A, B, C, D as specified by an occupant selection or a predetermined pressure setting.

The air bladder assembly array 50 includes an upright column of central air bladder regions 52, 54, 56, 58, each within one of the zones A, B, C, D for supporting the thoracic vertebrae. The upright column of central air bladder regions 52, 54, 56, 58 are arranged longitudinally within the seat back 14, or generally up and down along the seat back 14 in this environment. The first central air bladder region 52 is tapered outward towards the second central air bladder region 54 to fit between an occupant's shoulder blades. The first central air bladder region 52 is provided by a single air bladder region for zone A. Zones B, C and D each are provided by a single air bladder that is divided into multiple regions.

A first pair of lateral air bladder regions 60, 62 extends from opposed sides of the second central air bladder region 54 for supporting the ribs in the thoracic region. Each of the first pair of lateral air bladder regions 60, 62 is separated from the second central air bladder region 54 by a partial divider or hem line 64 to permit fluid communication of compressed air between the second central air bladder region 54 and the first pair of lateral air bladder regions 60, 62 for uniform inflation and pressure distribution in the zone B. The first pair of lateral air bladder regions 60, 62 is angled relative to the second central air bladder region 54 to incline laterally so that each zone A, B, C, D fits adequately within the thoracic region. According to one embodiment, the offset angle of the first pair of lateral bladder regions 60, 62 is within a range of fifteen to forty-five degrees, such as thirty degrees for example when measured at an upper or lower seam of the lateral bladder region 60, 62. Each of the first pair of lateral air bladder regions 60, 62 has a tapered width and may define an irregular quadrilateral shape, such as a trapezoid.

A second pair of lateral air bladder regions 66, 68 extends from opposed sides of the third central air bladder region 56 at an angle similar to the first pair of lateral air bladder regions 60, 62 and with an expanding width. A third pair of lateral air bladder regions 70, 72 extend from opposed sides of the fourth central air bladder region 58 at the angles described above to another tapered width.

The air bladder assembly array 50 also includes a central lumbar air bladder region 74 oriented below the fourth central air bladder region 58 to be aligned with the L2 and L3 vertebrae of the lumbar region. The central lumbar air bladder region 74 is oriented in an upper lumbar region. A first pair of lateral lumbar air bladder regions 76, 78 extend from opposed sides of the fourth central air bladder region 74 at the angles described above to another tapered width. A second pair of lateral lumbar air bladder regions 80, 82 is oriented below the first pair of lateral lumbar air bladder regions 76, 78. A central sacral air bladder region 83 is oriented beneath the second pair of lateral lumbar air bladder regions 80, 82.

The air bladder assembly array 50 provides targeted support, posture, stimulation and comfort to various regions within the thoracic region, as well as lumbar and sacral support.

The controller 22 receives adjustment settings from pre-set data or from customized data. The data may be input from an interface that is provided in the vehicle. The interface may be integrated into the vehicle, such as an instrument panel display that is in suitable wired or wireless communication with the controller 22. The interface may be remote, such as a personal digital assistant (PDA) including phones, tablets and the like. The interface may be provided as a smart device application, wherein users enter relevant information about themselves. The smart phone interface may not require on-site expertise or seat properties. The remote interface permits a user to transport settings to each vehicle, such as personal passenger vehicles, airline seating, rental cars, and the like.

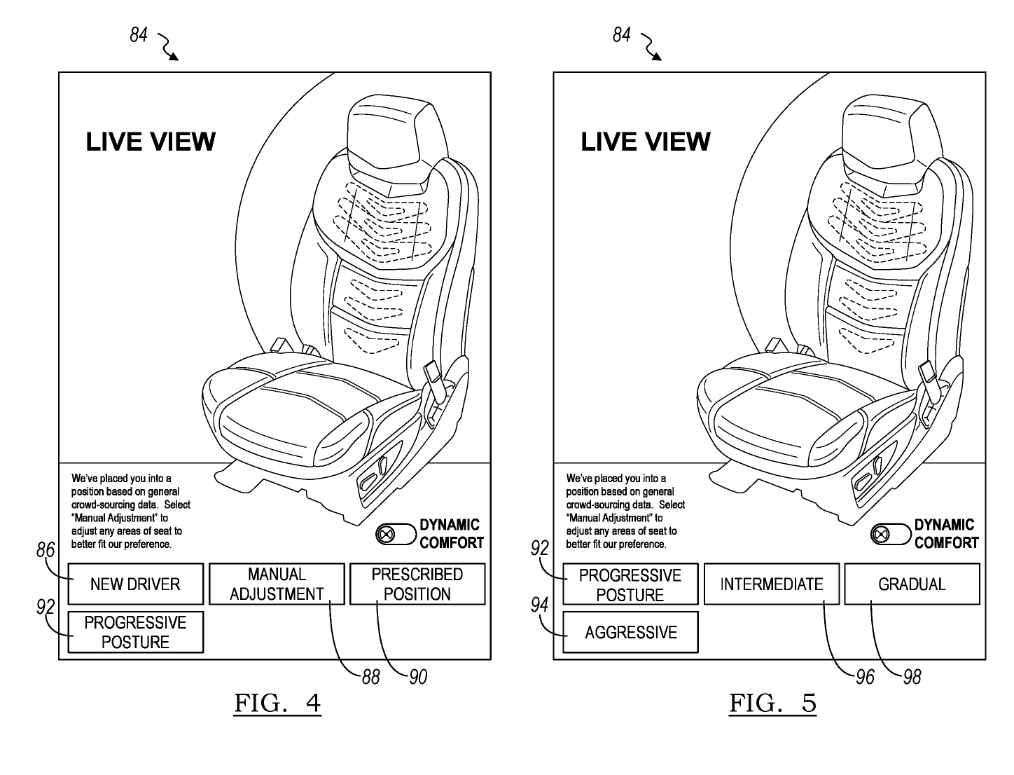

FIG. 4 illustrates a display image 84 from an interface, such as a tablet. FIG. 4 illustrates a screen wherein a data collection process can be initiated by selection of “New Driver” selection button 86. The data collection process is illustrated and described in Lear Corporation U.S. Patent Application Publication Number US 2015/0352979 A1, which is incorporated in its entirety be reference herein. The collected data can be utilized to adjust the seat assembly to the pre-set options, based on prior-collected data in knowledge base.

The display image 84 also offers an option to manual adjust the seat assembly 10 by selection of the “Manual Adjustment” selection button 88. The manual adjustment option is illustrated and described in greater detail in Lear Corporation U.S. Patent Application Publication Number US 2015/0351692 A1, which is incorporated in its entirety by reference herein.

The display image 84 also permits selection of adjustment to a “Prescribed Position” at selection button 90. The prescribed position is a predetermined target position for adjustment of the seat assembly 10 based upon anthropometric data of the occupant and predetermined adjustment ranges as selected by a health professional. The prescribed position adjustment is further described and illustrated in Lear Corporation U.S. Patent Application Publication Number US 2015/0352979 A1, and Zouzal et al. U.S. Patent Application Publication Number US 2015/0352990 A1, which are incorporated in their entirety by reference herein.

Seated occupants develop muscle memory over a passage of time. Abrupt changes in a seated position as a result of a correction to posture may be unwelcome or perceived as aggressive to an occupant that is more familiar to a seating position of poor posture. The adjustment of the seating position may be perceived with various results for various occupants depending upon the amount of adjustment, the health of the occupant, the wellness of the occupant, the age of the occupant, anthropometric data of the occupant, prolonged seating of the occupant, preferences of the occupant, and the like. Immediate posture correction of the seated position may appear aggressive when actuated by simultaneous correction of all regions of the air bladder assembly array 16, 50. Sequential posture correction of the seated position by sequentially inflating each region of the air bladder assembly array 16, 50 fully to the target position may also be undesired by some occupants.

The display image 84 also includes a “Progressive Posture” mode selection button 92. The progressive posture mode selection gradually adjusts the seat assembly 10 to the target position gradually over a period of time so that the posture correction is more acceptable to the occupant and the ontogeny of the occupant over a predetermined range of time. This gradual adjustment of the seat assembly 10 incrementally adjusts the seat assembly 10 over predetermined quantities of events so that the occupant can progressively accept the changes and develop muscle memory that evolves or adapts toward a corrected or prescribed posture seating position. Such gradual adjustment is more acceptable to occupants and therefore more likely to be utilized. With an increased likelihood in use, an increased health, wellness and posture is achieved by the occupants.

FIG. 4 illustrates the display image 84 after the “Progressive Posture” mode has been selected at button 92. At this time, the display image 84 offers a plurality of progressive posture modes. According to one embodiment, an “Aggressive” mode (selection button 94), an “Intermediate” mode (selection button 96), and a “Gradual” mode (selection button 98) are offered on the display screen. Each of these progressive posture modes (buttons 94, 96, 98) offers a varying rate of adjustment until reaching the target position.

The aggressive mode 94 adjusts to the target position over the shortest quantity of events. The gradual mode 98 adjusts to the target position of the longest quantity of events. The intermediate mode 96 adjusts to the target position over a quantity of events that is greater than the aggressive mode 94 and less than the gradual mode 98.

The quantity of events of the progressive posture modes 94, 96, 98 can be defined by activation periods or activation events. An activation event may be defined and measured as an event wherein the seat assembly 10 is adjusted. For example, the controller 22 may be in communication with an associated vehicle. In response to an input that indicates that the vehicle has been started, the controller 22 may inflate the air bladder assembly array 16, 50 from a deflated position to a partial target position, or the target position. Each start of the vehicle, and consequent inflation of the seat assembly, is counted as an activation event. Alternatively, the controller 22 may be in communication with one or more seat sensors that detect that an occupant is seated upon the seat assembly 10 before inflating the air bladder assembly array 16, 50. The controller 22 may utilize each detection of a seated occupant to increase a quantity of counted activation events.

According to one embodiment, selection of the aggressive progressive posture mode 94 assigns forty activation events to obtain the target position. For example, under the aggressive progressive posture mode 94, the controller 22 inflates the air bladder assembly array 16, 50 to ten percent of the displacement between a deflated position and the target position for the first ten cycles or activation events. Next, the controller 22 inflates the air bladder assembly array 16, 50 to thirty percent of the displacement for the next ten cycles. Subsequently, the controller 22 adjusts the air bladder assembly array 16, 50 to sixty percent of the inflation toward the target position for the next ten cycles. Lastly, the controller 22 inflates the air bladder assembly array 16, 50 fully to the target position for ten more cycles. The intermediate mode 96 assigns sixty-eight activation events, or ten percent inflation towards the target position, thirty percent inflation, sixty percent inflation and fully inflated at intervals of seventeen cycles each. The gradual mode 98 assigns ninety-eight activation events with intervals of twenty-four activation events before each increased partial and full adjustment. Of course, various intervals and repetitions may be employed to adjust over various settings.

According to at least one embodiment, selection of the progressive posture mode 92 may initially adjust the seat assembly 10 to the target position to demonstrate the proscribed position to the occupant. Subsequently, the controller 22 deflates the air bladder assembly array 16, 50 to ten percent inflation to begin the selected mode.

According to at least another embodiment, the controller 22 may select a prescribed progressive posture mode 94, 96, 98 based upon an inputted data, such as a function of age or health conditions.

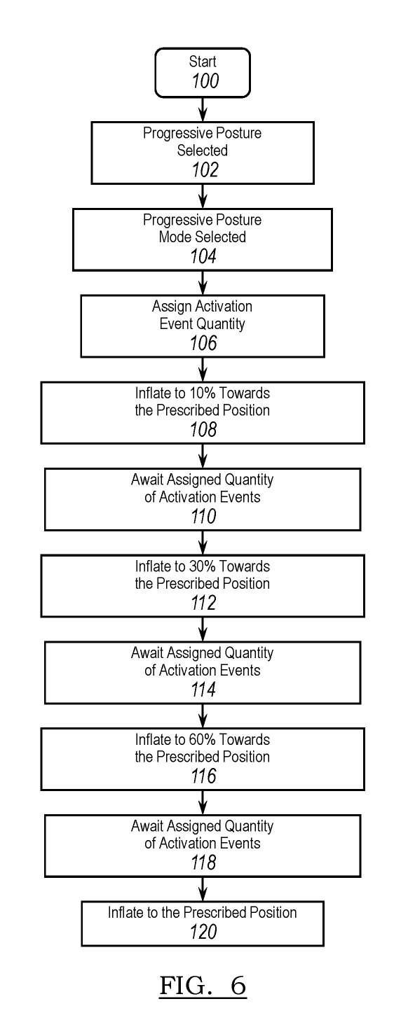

FIG. 6 illustrates a flowchart for a method for adjusting the seat assembly 10 according to an embodiment. The flowchart starts at block 100. At block 102, the progressive posture program is selected by button 92 on the display image 84. At block 104, one of the progressive posture modes 94, 96, 98 is selected. At block 106, an activation event quantity is assigned for selected mode 94, 96, 98, such as a total of forty, sixty-eight or ninety-eight activation events. At block 108 the air bladder assembly array 16, 50 is inflated to ten percent of the displacement between uninflated and the target posture position. At block 110, the controller awaits until one-fourth of the activation events have cycled. Then the air bladder assembly array 16, 50 is inflated to thirty percent of the displacement at block 112. Another interval of activation events passed during block 114. At block 116, the controller adjusts the seat assembly 10 to sixty percent inflation towards the targeted position. Another interval of activation events is counted at block 118. After the assigned interval of activation events is passed at block 118, the air bladder assembly array 16, 50 is fully inflated to the target position at block 120.

According to an embodiment, the target position is maintained for the remainder of the assigned activation events at block 120. Then, the target position is maintained for subsequent cycles of the seat assembly 10. Alternatively, the progressive posture mode 92 may automatically selected the prescribed position adjustment setting 90.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A seat assembly comprising:
a seat back;
an actuator oriented in a region of the seat back to adjust a seating surface of the seat back; and
a controller in electrical communication with the actuator and programmed to:
operate the actuator to partially adjust the seating surface to a first adjustment position toward a target position, and
subsequently operate the actuator to further actuate the actuator after a predetermined delay to further adjust the seating surface to a second adjustment position toward the target position.

2. The seat assembly of claim 1 wherein the controller is further programmed to subsequently operate the actuator to further adjust the seating surface to the target position after another predetermined delay.

3. The seat assembly of claim 1 wherein the controller is further programmed to subsequently operate the actuator to further adjust the seating surface incrementally after the second adjustment position, and after a plurality of incremental delays until the seating surface is fully actuated to the target position.

4. The seat assembly of claim 1 wherein the actuator further comprises an array of air bladder assemblies.

5. The seat assembly of claim 1 wherein the controller is programmed to operate the actuator to partially adjust the seating surface to generally ten percent of a displacement between an initial position and the target position for the first adjustment position.

6. The seat assembly of claim 5 wherein the controller is programmed to operate the actuator to further adjust the seating surface to generally thirty percent of the displacement between the initial position and the target position for the second adjustment position in response to the predetermined delay.

7. The seat assembly of claim 6 wherein the controller is programmed to operate the actuator to further adjust the seating surface to generally sixty percent of the displacement between the initial position and the target position for a third adjustment position in response to a second predetermined delay.

8. The seat assembly of claim 7 wherein the controller is programmed to operate the actuator to further adjust the seating surface to the target position for a fourth adjustment position in response to a third predetermined delay.

9. The seat assembly of claim 1 wherein the predetermined delay comprises a predetermined a quantity of activation events of the seat assembly.

10. The seat assembly of claim 9 wherein the seat assembly is in cooperation with a vehicle; and
wherein the controller is further programmed to:
receive input indicative of an initiation of the vehicle, and
increase a count of activation events of the quantity of activation events in response to receipt of the input indicative of the initiation of the vehicle.

11. The seat assembly of claim 9 wherein the controller is further programmed to:
receive input indicative of receipt of an occupant upon the seat assembly; and
increase a count of activation events of the quantity of activation events in response to receipt of input indicative of receipt of the occupant upon the seat assembly.

12. The seat assembly of claim 9 wherein the controller is further programmed to:
receive input indicative of a selection of a mode of seat adjustment; and
select the predetermined quantity of activation events in response to the selected mode.

13. The seat assembly of claim 12 wherein the controller is further programmed to:
receive input indicative of a selection of a first mode of seat adjustment;
select a first quantity of activation events in response to the selection of the first mode;
receive input indicative of a selection of a second mode of seat adjustment; and
select a second quantity of activation events that is different that the first quantity of activation events, in response to selection of the second mode.

14. The seat assembly of claim 1 wherein the target position is defined by biometrically optimized data.

15. A seat assembly comprising:
a seat back;
an actuator oriented in a region of the seat back to adjust a seating surface of the seat back;
a controller in electrical communication with the actuator and programmed to:
receive input indicative of a selection of a mode of seat adjustment; and
operate the actuator to gradually adjust the seating surface to a target position after a predetermined quantity of events associated with the selected mode of seat adjustment.

16. The seat assembly of claim 15 wherein the controller is further programmed to:
receive input indicative of a selection of a first mode of seat adjustment;
select a first predetermined quantity of events in response to the selection of the first mode;
receive input indicative of a selection of a second mode of seat adjustment; and
select a second predetermined quantity of events that is different that the first predetermined quantity of events, in response to selection of the second mode.

17. The seat assembly of claim 16 wherein the first predetermined quantity of events comprises a first quantity of activation events of the seat assembly;
wherein the second predetermined quantity of events comprises a second quantity of activation events of the seat assembly; and
wherein the second quantity of activation events of the seat assembly is greater than the first quantity of activation events.

18. The seat assembly of claim 17 wherein the controller is further programmed to:
receive input indicative of a selection of a third mode of seat adjustment; and
select a third predetermined quantity of activation events that is different from the first predetermined quantity of activation events and the second predetermined quantity of activation events, in response to selection of the third mode.

19. The seat assembly of claim 18 wherein the first quantity of activation events comprises forty activation events;
wherein the second quantity of activation events comprises sixty-eight activation events; and
wherein the third quantity of activation events comprises ninety-six activation events.

20. A computer-program product embodied in a non-transitory computer readable medium that is programmed to adjust a seat assembly, the computer-program product comprising instructions to:
operate an actuator oriented in a region of a seat back to adjust a seating surface of the seat back to a first adjustment position toward a target position; and
subsequently operate the actuator to further actuate the actuator after a predetermined delay to further adjust the seating surface to a second adjustment position toward the target position.
